(19) United States
(12) Patent Application Publication
(10) Pub. No.: US 2024/0241690 A1
(43) Pub. Date: Jul. 18, 2024

(54) ACOUSTIC REMOTE CONTROL INTERFACE FOR HEADSETS

(71) Applicant: Intel Corporation, Santa Clara, CA (US)

(72) Inventors: Sebastian Rosenkiewicz, Gdansk (PL); Adam Kupryjanow, Gdansk (PL); Lukasz Pindor, Pruszcz Gdanski, Pomorskie, 83-000 (PL)

(73) Assignee: Intel Corporation, Santa Clara, CA (US)

(21) Appl. No.: 18/428,214

(22) Filed: Jan. 31, 2024

(51) Int. Cl. G06F 3/16; H04R 1/10

(52) U.S. Cl. CPC G06F 3/165; H04R 1/1041; H04R 2430/01

(57) ABSTRACT

Techniques are provided herein for implementing headset control functions for low-end consumer-grade headsets using a firmware module implemented in the computing platform. The techniques can include a microphone mute function, a headset speaker volume function, and other headset functions. In particular, acoustic events are utilized to control headset functions. Because the headset control components are inside system firmware, the headset control module is endpoint agnostic and will work with any headset coupled to the computing platform. The computing device through which a voice call is implemented can include an event trigger detector, which detects selected acoustic events and triggers a corresponding action. The system allows for control of the voice call via custom user acoustic events. In some examples, the acoustic event that mutes the microphone can be a finger tap. A finger tap generally has a short duration and is easily detectable.

### TECHNICAL FIELD

This disclosure relates generally to headsets, and in particular to headsets having a speaker and a microphone.

### BACKGROUND

Headsets are often used for telecommunications and calls in various work environments.

With the increase of hybrid and/or remote working models, there is an increase in the use of consumer-grade headsets which are generally not equipped with a microphone mute button.

Microphone mute options in many office setups can include a software driver stack level mute, a firmware driver stack level mute, an operating system level mute, an application level mute, and, potentially, a headset hardware mute button. Depending on the headset, each mute option can potentially be an independent mute control or a mute control paired with a second mute option. Managing multiple independent mute controls can be a source of problems for a headset user.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a deep learning system, in accordance with various embodiments.

FIG. 2 is a block diagram illustrating an example of an acoustic remote control system for a computing device, in accordance with various embodiments

FIG. 3 is a diagram illustrating an example of an acoustic remote control system between a headset and a computing device, in accordance with various embodiments.

FIG. 4 illustrates an example framework for an acoustic remote control system for muting a microphone coupled to a computing device, in accordance with various embodiments.

FIG. 5 is a flow chart illustrating an example method 500 for control of headset audio data, in accordance with various embodiments.

FIG. 6 is a block diagram of an example computing device, in accordance with various embodiments.

### DETAILED DESCRIPTION

### Overview

With the increase of hybrid and/or remote working models, there is an increase in the use of consumer-grade headsets which are generally not equipped with a microphone mute button. Techniques are provided herein for implementing a mute function in low-end consumer-grade headphones. The techniques can also be used to adjust headset speaker volume and for other headset functions. In particular, acoustic events are utilized to control microphone functions such as mute and headset volume level. The computing device through which a voice call is implemented can be updated to include an event trigger detector, which allows for control of the voice call via custom user acoustic events. In some examples, the event trigger detector can be included in computing device audio firmware. In some examples, the acoustic event that mutes the microphone can be a finger tap. A finger tap generally has a short duration and is easily detectable.

In general, conventional headset microphone mute options have been implemented in hardware, such as a mute button on a headset, a mute button on a computing device and/or keyboard, and an external mute button. However, hardware solutions use various expensive hardware components, and a user must be close to the device to use the mute button. Alternatively, headset microphone mute options have been implemented in software, for instance based on detection of a wake-up phrase that enables a microphone mute, and/or based on proximity detection such that a microphone is enabled when user proximity is detected and a microphone is muted when no user is detected in proximity to the microphone. However, the use of a wake-up phrase includes the wake-up phrase being transmitted in the voice call, which can be undesirable to an end user. To remove the wake-up phrase, a significant latency is introduced to the microphone stream, making removal impractical. In particular, the microphone signal would be delayed by the time it takes to detect the wake-up phrase (e.g., ˜200 ms onset +˜500 ms wake-up phrase duration +˜200 ms offset) such that when the wake-up phrase is detected, the stream is muted and the wake-up phrase is removed. To mute a microphone based on proximity, the microphone is moved far from the user's body to enable mute function, which can be inconvenient, especially when the microphone is connected to the headphones (and/or earphones) in a single headset.

Systems and methods are presented herein to provide a computing platform equipped with a headset control function for use during a voice call, including a microphone mute function, and headset speaker volume function. The systems and methods can be used on wired and wireless headsets. Because the headset control function is a firmware module implemented in the computing platform, there is no increased cost to provide the feature to end users. Additionally, because the headset control components are inside system firmware, the headset control module is endpoint agnostic and will work with any headset coupled to the computing platform. Thus, once the headset control module is configured in a computing device, the module functions for any headset coupled to the computing device. Note that the headset control module is implemented in firmware because operating systems generally do not allow audio processing in kernel space.

According to various implementations, the headset control module includes an event trigger detector component which can be implemented as a neural network, such as a deep neural network (DNN). As described herein, a DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN System

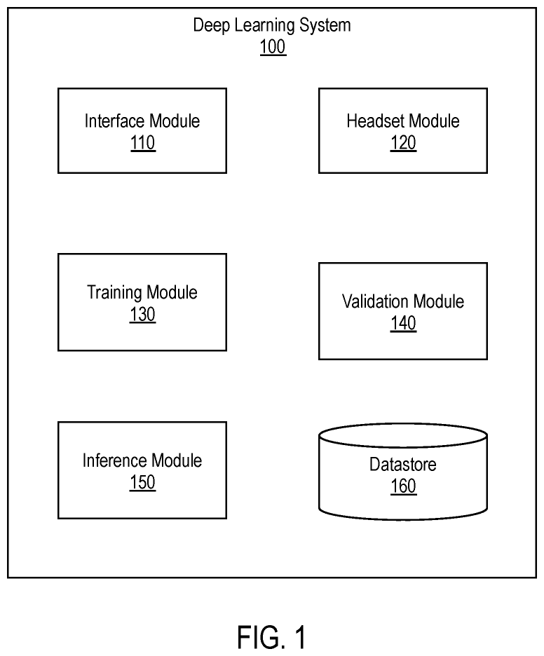

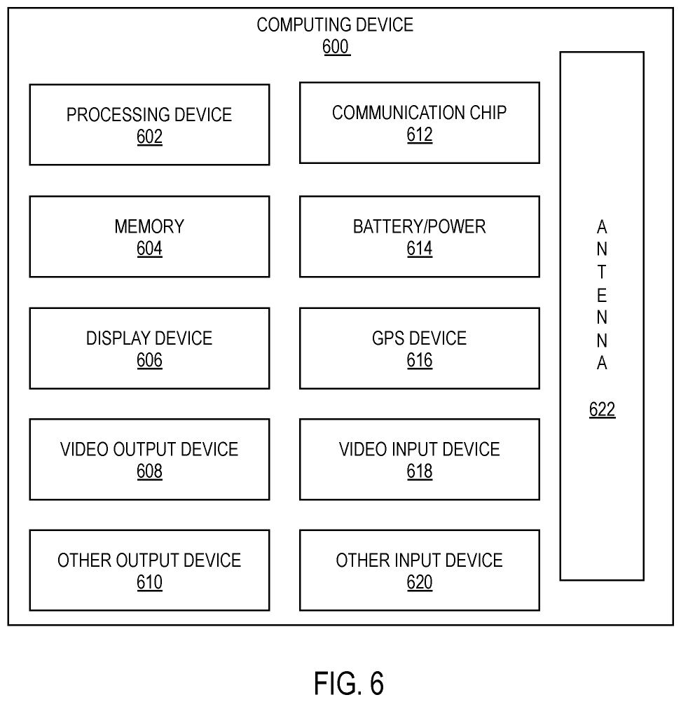

FIG. 1 is a block diagram of an example deep learning system 100, in accordance with various embodiments. In some examples, the deep learning system 100 is a deep neural network (DNN). The deep learning system 100 trains DNNs for various tasks, including acoustic event detection and/or acoustic signal denoising, which can be used, for example, to detect an acoustic event such as a finger tap and to remove the acoustic event from the transmitted signal. In some examples, the headset module 120 can be used for audio data, such as voice data. In various examples, the headset module 120 can be trained to identify selected acoustic events. The deep learning system 100 includes an interface module 110, a headset module 120, a training module 130, a validation module 140, an inference module 150, and a datastore 160. In other embodiments, alternative configurations, different or additional components may be included in the deep learning system 100. Further, functionality attributed to a component of the deep learning system 100 may be accomplished by a different component included in the deep learning system 100 or a different system. The deep learning system 100 or a component of the deep learning system 100 (e.g., the training module 130 or inference module 150) may include the computing device 600 in FIG. 6.

The interface module 110 facilitates communications of the deep learning system 100 with other systems. As an example, the interface module 110 supports the deep learning system 100 to distribute trained DNNs to other systems, e.g., computing devices configured to apply DNNs to perform tasks such as headset control. As another example, the interface module 110 establishes communications between the deep learning system 100 with an external database to receive data that can be used to train DNNs or input into DNNs to perform tasks. In some embodiments, data received by the interface module 110 may have a data structure, such as a matrix. In some embodiments, data received by the interface module 110 may be an audio clip, a sound bite, and/or an audio stream. In some examples, data received by the interface module 110 can extend to the non-audible spectrum, such as sound above or below a selected volume and/or frequency.

The headset module 120 processes audio data received from a microphone. In some examples, the headset module 120 identifies acoustic events in a real time audio data stream. The headset module 120 can be implemented in firmware. In some examples, the headset module 120 results in compression of the DNN model by identifying areas of interest in the audio data and reducing the number of weights and biases to be processed. In some examples, the headset module 120 removes one or more acoustic events from the audio data stream. In some examples, the headset module 120 mutes a microphone based on the identification of an acoustic event.

The training module 130 trains DNNs by using training datasets. In some embodiments, a training dataset for training a DNN may include one or more of an audio clip, a sound bite, and/or an audio stream, each of which may be a training sample. The training module 130 may receive the audio data for processing with the headset module 120 as described herein. In some examples, the headset module 120 generates starting values for the model, and the training module 130 uses the starting values at the beginning of training. In some embodiments, the training module 130 may input different data into different layers of the DNN. For every subsequent DNN layer, the input data may be less than the previous DNN layer. The training module 130 may adjust internal parameters of the DNN to optimize identification of acoustic events at the headset module 120.

In some embodiments, a part of the training dataset may be used to initially train the DNN, and the rest of the training dataset may be held back as a validation subset used by the validation module 140 to validate performance of a trained DNN. The portion of the training dataset not including the tuning subset and the validation subset may be used to train the DNN. In some examples, the DNN uses data augmentation. Data augmentation is a method of increasing the training data by creating modified copies of the dataset, such as making minor changes to the dataset or using deep learning to generate new data points.

The training module 130 also determines hyperparameters for training the DNN. Hyperparameters are variables specifying the DNN training process. Hyperparameters are different from parameters inside the DNN (e.g., weights, biases). In some embodiments, hyperparameters include variables determining the architecture of the DNN, such as number of hidden layers, filters, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 130 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input audio data, such as input frequencies, input amplitudes, and various acoustic events. The output layer includes labels of acoustic events in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input audio data to a feature map that represents features of the audio data. A pooling layer can be used to reduce the spatial volume of input audio data after convolution. A pooling layer can be used between 2 convolution layers.

In the process of defining the architecture of the DNN, the training module 130 also uses a selected activation function for a hidden layer or the output layer. An activation function of a layer transforms the weighted sum of the input of the layer to an output of the layer. The activation function may be, for example, a rectified linear unit activation function, a tangent activation function, or other types of activation functions.

After the training module 130 receives the initial weights and biases for the DNN from the headset module 120, the training module 130 inputs a training dataset into the DNN. The training dataset includes a plurality of training samples. An example of a training dataset includes an audio stream. An example of a training sample includes an acoustic event in an audio clip and an identification of the acoustic event. The training data is processed using the headset module parameters of the DNN to produce a model-generated output, and updates the weights and biases to increase model output accuracy. The training module 130 modifies the parameters inside the DNN (“internal parameters of the DNN”) to minimize the error between identification of acoustic events as generated by the DNN and the ground-truth acoustic event identifications. The internal parameters include weights of filters in the convolutional layers of the DNN. In some embodiments, the training module 130 uses a cost function to minimize the error.

The training module 130 may train the DNN for a predetermined number of epochs. The number of epochs is a hyperparameter that defines the number of times that the deep learning algorithm will work through the entire training dataset. In some examples, when batch size equals one, one epoch means that each sample in the training dataset has had an opportunity to update internal parameters of the DNN. In some examples, the batch size is greater than one, and more samples are processed before parameters are updated. After the training module 130 finishes the predetermined number of epochs, the training module 130 may stop updating the parameters in the DNN. The DNN having the updated parameters is referred to as a trained DNN.

The validation module 140 verifies accuracy of trained DNNs. In some embodiments, the validation module 140 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 140 may determine an accuracy score measuring the precision, recall, or a combination of precision and recall of the DNN. The validation module 140 may use the following metrics to determine the accuracy score. In particular, the precision (P) can be how many the reference classification model correctly predicted (i.e., true positives (TP)) out of the total number it predicted (true positives plus false positives (FP)): Precision=TP/(TP+FP) Recall (R) may be how many the reference classification model correctly predicted (TP) out of the total number of objects that did have the property in question (TP+FN or false negatives): Recall =TP/(TP+FN). The F-score (F-score=2*PR/(P+R)) unifies precision and recall into a single measure.

The validation module 140 may compare the accuracy score with a threshold score. In an example where the validation module 140 determines that the accuracy score of the augmented model is lower than the threshold score, the validation module 140 instructs the training module 130 to re-train the DNN. In one embodiment, the training module 130 may iteratively re-train the DNN until the occurrence of a stopping condition, such as the accuracy measurement indication that the DNN may be sufficiently accurate, or a number of training rounds having taken place.

The inference module 150 applies the trained or validated DNN to perform tasks. The inference module 150 may run inference processes of a trained or validated DNN. In some examples, inference makes use of the forward pass to produce model-generated output for unlabeled real-world data. For instance, the inference module 150 may input real-world data into the DNN and receive an output of the DNN. The output of the DNN may provide a solution to the task for which the DNN is trained for.

The inference module 150 may aggregate the outputs of the DNN to generate a final result of the inference process. In some embodiments, the inference module 150 may distribute the DNN to other systems, e.g., computing devices in communication with the deep learning system 100, for the other systems to apply the DNN to perform the tasks. The distribution of the DNN may be done through the interface module 110. The computing devices may be connected to the deep learning system 100 through a network. Examples of the computing devices include edge devices.

The datastore 160 stores data received, generated, used, or otherwise associated with the deep learning system 100. For example, the datastore 160 stores audio data processed by the headset module 120 or used by the training module 130, validation module 140, and the inference module 150. The datastore 160 may also store other data generated by the training module 130 and validation module 140, such as the hyperparameters for training DNNs, internal parameters of trained DNNs (e.g., values of tunable parameters of activation functions, such as

Fractional Adaptive Linear Units (FALUs)), etc. In the embodiment of FIG. 1, the datastore 160 is a component of the deep learning system 100. In other embodiments, the datastore 160 may be external to the deep learning system 100 and communicate with the deep learning system 100 through a network.

### Example Headset Control System

Systems and methods are presented herein for an acoustic remote control interface in a computing device for controlling a headset coupled to the computing device. In particular, computing device firmware can be enhanced with a headset module that identifies acoustic events in an audio stream and control microphone functions such as mute and volume level. A lightweight event trigger detector allows for control of a voice call via custom user acoustic events.

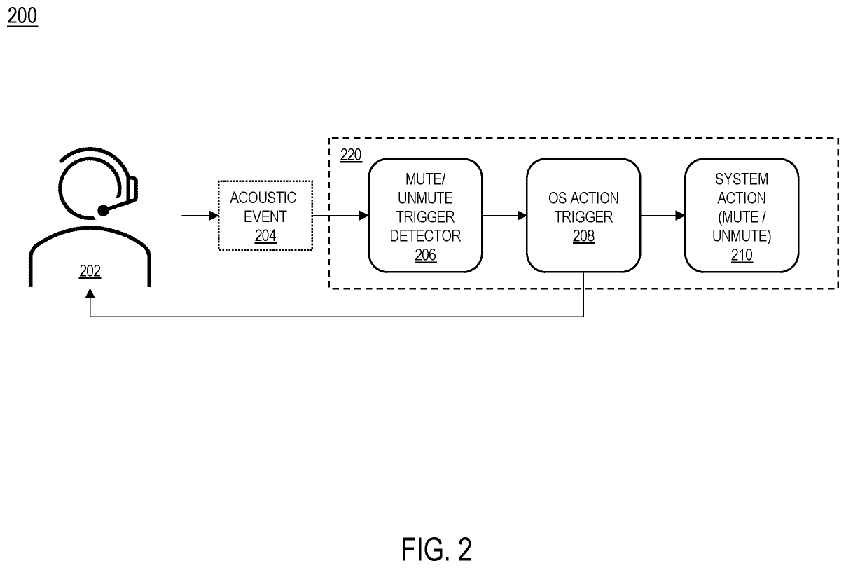

FIG. 2 is a block diagram 200 illustrating an example of an acoustic remote control system for a computing device, in accordance with various embodiments. In particular, the block diagram 200 includes a headset module 220, such as the headset module 120 described above with respect to FIG. 1. The headset module 220 can be implemented as firmware in a computing device to which the headset 202 is connected. As shown in FIG. 2, a headset 202 is in use by a user for a voice call, and as such an audio data stream is received by the headset speakers (e.g., headphones and/or earphones) and an audio data stream is transmitted from the headset microphone. In particular, when the user speaks, audio data including the user's voice is picked up by the headset microphone and transmitted from the headset. The headset is coupled to a computing device through which the voice call is connected. For example, the voice call can be a VOIP (voice over internet protocol) call, a telecommunications call, a remote meeting conducted over a cloud service, and/or other online connection. The computing device processes audio data received from the headset at the headset module 220.

The headset module 220 in the computing device receives the transmitted audio data from the headset 202. Additionally, the headset module 220 receives any acoustic events 204 picked up by the headset 202. For example, an acoustic event can include a fingertap on the microphone, a finger scratch on the microphone, a particular sound vocalized by the user, and/or any other sound otherwise produced by the user (e.g., tapping fingers, snapping fingers, whistling, clicking, or other non-speech sound). The acoustic event 204 is part of the audio data transmitted from the headset 202 to the headset module 220.

At the headset module 220, the incoming audio data is received at a mute/unmute trigger detector 206. The mute/unmute trigger detector 206 is configured to detect acoustic events 204. In some examples, the mute/unmute trigger detector 206 is a neural network trained to identify selected acoustic events 204, as described above with respect to FIG. 1. The mute/unmute trigger detector 206 determines whether any identified acoustic events trigger a microphone mute (or unmute) action. For example, the headset module 220 can be set up such that a microphone fingertap event causes microphone mute (or unmute). In this example, the mute/unmute trigger detector 206 identifies an acoustic event as a microphone fingertap and initiates a microphone mute.

When the mute/unmute trigger detector 206 initiates a microphone mute, a microphone mute instruction is transmitted to an operating system (OS) action trigger block 208. The OS action trigger block 208 transmits a notification to the headset 202 speakers notifying the user of the microphone mute action. Thus, the user receives confirmation of an intended mute action, and, if the user did not intend to mute the microphone, the user can unmute the microphone. Additionally, the OS action trigger block 208 transmits an instruction to block 210 to cause a system-level mute action, such that any audio input to the headset module 220 and to the computing device is muted.

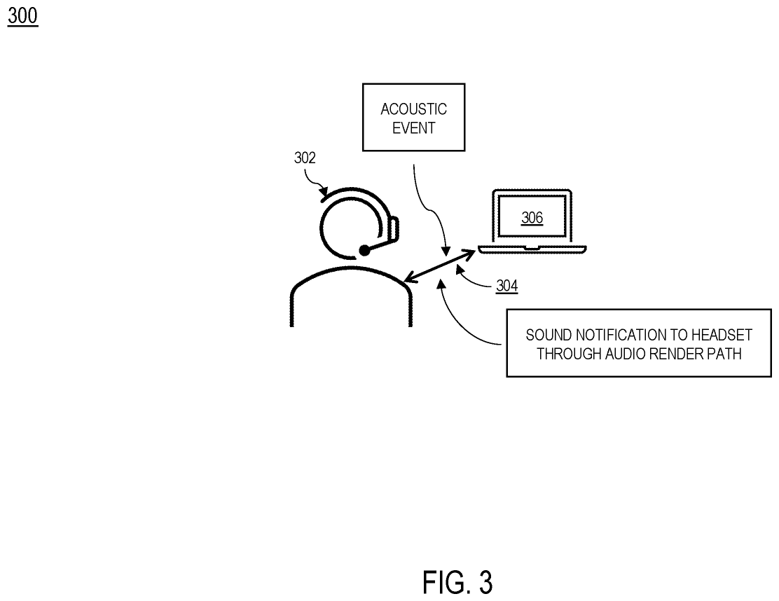

FIG. 3 is a diagram 300 illustrating an example of an acoustic remote control system between a headset 302 and a computing device 306, in accordance with various embodiments. The headset 302 can be a wireless headset or a wired headset, and the headset can be a variable distance 304 from the computing device 306. In various examples, the headset 302 includes a microphone, and the headset 302 can include one or more headphones, earphones, earbuds, and/or headbuds. In some examples, the headset can include any device with a speaker and a microphone. A wireless headset 302 can be connected to the computing device 306 using any selected wireless connection technology, such as, for example, Bluetooth, WiFi, NFC, Zigbee, Wireless Personal Area Networks (PANs), and infrared light. The computing device 306 can include a headset module installed in device firmware, such as the headset module 120 and/or the headset module 220. The headset module in the computing device receives audio input from the headset 302, including any acoustic event such as a microphone tap and/or scratch. Additionally, the headset module in the computing device 306 can transmit a sound notification to the headset through an audio render path. For instance, the sound notification can play through headset speakers to alert the user that the microphone has been muted.

A microphone mute control is described above, and in various examples, the headset module can identify acoustic event and manage a different control. In some examples, the headset module can identify multiple different acoustic event types, and each event type can manage a different control causing a different effect. Additionally, while a microphone fingertap is one type of acoustic event, other single or multiple acoustic events can be identified by the headset module and be used for different controls.

### Example Headset Control Framework

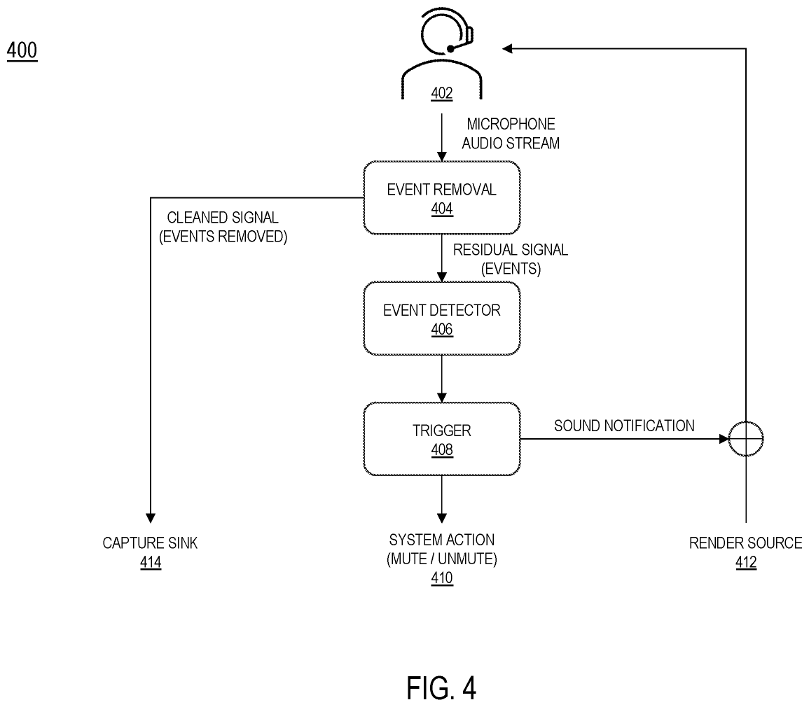

FIG. 4 illustrates an example framework for an acoustic remote control system 400 for muting a microphone coupled to a computing device, in accordance with various embodiments. The acoustic remote control system 400 is a firmware platform feature that can controls system level mute and/or other system level headset functions (e.g., speaker volume level, microphone volume level, etc.). In some examples, the acoustic remote control system 400 includes a headset module as described above. For purposes of the description of the acoustic remote control system 400 with respect to FIG. 4, the mute function will be used as the system level function of the framework.

According to various examples, for purposes of muting a speaker wearing a headset 402, the system 400 functions similarly to the mute button in an operating system or in a virtual meeting application. In various examples, the mute feature is complementary to the operating system and applications, such that the mute can be performed from an application and an unmute function can be performed from a headset 402. Similarly, the mute can be performed from a headset 402 and the unmute can be performed from an application.

As shown in FIG. 4, a microphone audio stream from a headset 402 is input to an event removal block 404. The event removal block 404 processes the microphone audio stream and outputs two separate audio streams: a cleaned signal audio stream in which events are removed, and a residual signal stream which includes the events removed from the audio stream. In some examples, event removal can be implemented using a Dynamic Noise Suppression (DNS) technique. The DNS technique can be any type of DNS technique that can efficiently remove event sounds such as microphone finger taps, microphone scrapes, microphone scratches, etc. In various examples, event removal can be performed with a neural network, such as a deep neural network and/or a convolutional neural network. In some examples, the event removal technique is a low latency neural network, having a latency of less than 10 ms, and the event removal technique is also a low compute technique that has a low memory footprint.

In some examples, the event removal technique is a neural network denoiser that is trained to detect one or more selected acoustic event types. In some examples, to minimize degradation of useful sound content (i.e., sound other than the acoustic event), a deployed neural network denoiser model handles a single event type (e.g., microphone tapping). When the neural network denoiser of the event removal block 404 removes an acoustic event, the neural network denoiser provides clean audio content to a capture sink 414, free of any sounds of the acoustic event. The capture sink 414 is a software module on the computing device from which the voice call (and/or teleconference, online meeting, and/or other application) can receive the clean audio content in real time. In some examples, the clean audio content is transmitted from the microphone to the voice call (or other application) with a latency of less than 10 ms. In various examples, when the neural network denoiser of the event removal block 404 removes an acoustic event, the neural network denoiser does not perform full speech denoising. In some examples, focusing on removal of a single type of acoustic event (rather than removing multiple types of acoustic events) minimizes the compute and memory footprint of the event removal block 404. The residual signal from the event removal block 404 includes the acoustic event, and is input to the event detector block 406. In various examples, by using a denoiser at the event removal block 404, the acoustic event sound is prevented from leaking to the capture sink 414, while the latency of the clean audio data transmission remains low. In some examples, the clean audio content includes voice and speech content.

The event detector block 406 receives the residual signal from the event removal block. The residual signal is the part of the audio stream that was removed from microphone audio stream to generate the clean audio content. Thus, the residual signal includes the acoustic event, and the residual signal does not include any of the clean audio content that was transmitted to the capture sink 414. Since the residual signal includes sounds of acoustic events free of speech and voice content, the event detector block 406 has a very low footprint. The event detector block 406 includes a neural network detector trained to detect a selected acoustic event. In some examples, the event detector block 406 includes a neural network detector trained to detect a finger tap event. In some examples, the event detector block 406 includes a neural network detector trained to detect other types of acoustic events. The event detector block 406 has a higher latency than the event removal block 404, since the event detector collects more audio data. In some examples, the acoustic event that triggers a microphone mute is a double finger tap, and the finger taps can be spaced 200-400 ms apart. Thus, the event detector block 406 can have a latency between 500-1000 ms. When the selected acoustic event (or events) is identified at the event detector block 406, the trigger block 408 triggers the selected control function. In one example, after the event detector block 406 detects a second finger tap, the event detector activates the trigger block 408. The trigger block 408 initiates the system action 410. In some examples, the trigger block 408 receives notifications from the event detector block 406. As shown in FIG. 4, the system action 410 is a mute (or unmute) action, such that the trigger block 408 causes a microphone mute or unmute action.

The trigger block 408 also generates a sound notification to alert the user that the system action 410 was taken. In some examples, the trigger block 408 generates sound notification such as a “microphone mute” notification and the sound notification is mixed with the output from the render source 412 (e.g., sound output to the headset speakers) and transmitted to the headset speakers. In some examples, a trigger block 408 creates a “microphone unmute” notification which is mixed with the render source 412 output and transmitted to the headset speakers. In some examples, the notification can indicate a different system action. In other examples. The sound notification is a beep, tone, or other indication that the microphone is muted or unmuted. According to various implementations, the sound notification allows a user to correct any false acceptances and/or false rejections by the event detector block 406. The sound notification is generated at the system level audio block and mixed with the sound received at the audio block for transmission to the headset speakers, and as such the sound notification is played only to the headset 402 and is not transmitted to the voice call, teleconference, or other users.

Note that the latency of the event detector block 406 does not affect the audio stream, which is transmitted in near real time (less than 10 ms latency) from the event removal block.

The latency of the event detector block 406 affects the time between the last finger tap and a microphone mute action (or other headset control action). In general, a latency of about one second for a headset control action is tolerable from a user experience point of view.

According to various examples, the event removal block 404 and the event detector block 406 are part of a headset module implemented in the firmware of a computing device. The trigger block 408 which causes the system action can be implemented in software at the operating system level.

According to various implementations, the event removal block 404 and the event detector block 406 are each a signal processing module. The event removal block 404 can be a neural network that is trained using methods similar DNS network training techniques. For the event removal block 404, the target for the neural network is the acoustic event, as opposed to the target of a typical DNS network model, which is clean speech. Thus, in some examples, the target for the neural network is microphone tapping and/or microphone scratching. The event removal block 404 neural network denoiser model generates a signal including only the acoustic event. The clean speech signal that is transmitted to the capture sink is generated by subtracting the event removal block 404 neural network denoiser output from the input signal.

In some examples, the event detector block 406 can be a neural network classifier. The neural network classifier receives the neural network denoiser output from the event response block 404 and classifies the acoustic event. In some examples, the event detector block 406 is implemented as a digital signal processing (DSP) algorithm.

To train the neural network denoiser for the event removal block 404 and to train a neural network classifier for the event detector block 406, a dataset including the target events is generated. The target events can include, for example, microphone tapping events and microphone scratching events. The events can be labeled and/or classified for training. The dataset including the target events can be generated from one or more recordings. Data in the recordings can be augmented for training purposes. Data augmentation can include, for example, identifying and labeling acoustic events. In various examples, recordings used for training data can be recorded with a variety of headsets, including both earbud headsets, regular over the ear headsets, wired headsets, and wireless headsets. Additionally, for each of the variety of headsets, multiple users can generate the recordings, since each user can perform the event in a different way, adding to dataset variation. In various examples, acoustic events can be preceded and/or followed by a variable silence length, acoustic events can be mixed with speech, and accidental acoustic events can be simulated during speech to train the model to avoid false detections.

Note that when a headset microphone is muted using the system discussed herein, the microphone is muted at the computing device, such that no microphone data is transmitted to the voice call, teleconference, virtual meeting, etc. However, the audio block at the computing device still receives microphone data. Thus, the headset module described above still receives microphone data, and can identify an acoustic event that can trigger an unmute action.

### Method for Controlling Headset Audio Data

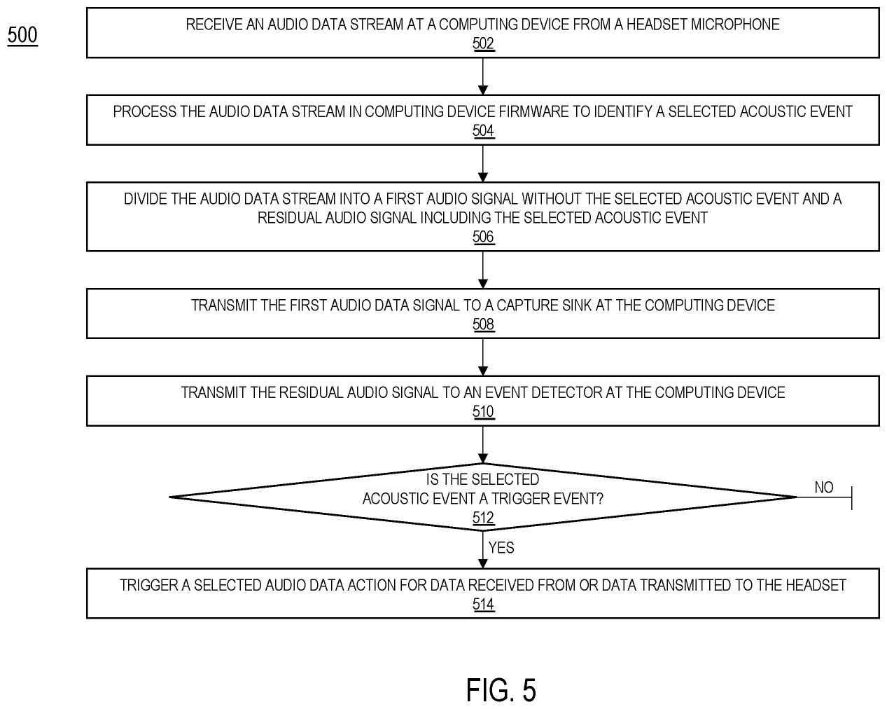

FIG. 5 is a flow chart illustrating an example method 500 for control of headset audio data, in accordance with various embodiments. At step 502, an audio data stream is received at a computing device. The audio data stream is received from a headset microphone. In some examples, the computing device includes a headset module installed in computing device firmware as described above. In various examples, the method 500 is initiated when a selected acoustic event is received in the audio data stream. At step 504, the audio data stream is processed in computing device firmware, such as at a headset module, to identify a selected acoustic event. As described above, the selected acoustic event can be identified by a neural network trained to identify the selected acoustic event, such as at a headset module.

At step 506, the audio data stream is divided into a first audio signal without the selected acoustic event and a residual audio signal including the selected acoustic event. In various examples, step 506 is performed at an event removal block such as the event removal block 404 described with respect to FIG. 4. At step 508, the first audio data signal (a cleaned signal in which the selected acoustic event is removed) is transmitted to a capture sink at the computing device. The audio data received at the capture sink is transmitted to the voice call, teleconference, virtual meeting, VOIP call, or other real-time audio interface. As step 510, the residual audio signal is transmitted to an event detector at the computing device.

At 512, it is determined whether the selected acoustic event is a trigger event. In particular, the event detector receives the residual audio signal including the selected acoustic event, evaluates the selected acoustic event, and determines whether the selected acoustic event is a trigger event. In some examples, the event detector is a neural network trained to classify received acoustic events. When the event detector determines that the selected acoustic event is a trigger event, the method 500 proceeds to step 514, and a selected audio data action is triggered. In some examples, the selected audio action is an action on data received from the headset microphone. For instance, the selected audio action can be a microphone mute action or a microphone unmute action. In some examples, the selected audio action is an action on data transmitted to the headset speakers. For instance, the selected audio action can be a speaker volume increase or a speaker volume decrease. When the event detector determines that the selected acoustic event is not a trigger event, the method 500 ends until another selected acoustic event is received.

### Example Computing Device

FIG. 6 is a block diagram of an example computing device 600, in accordance with various embodiments. In some embodiments, the computing device 600 may be used for at least part of the deep learning system 100 in FIG. 1. A number of components are illustrated in FIG. 6 as included in the computing device 600, but any one or more of these components may be omitted or duplicated, as suitable for the application. In some embodiments, some or all of the components included in the computing device 600 may be attached to one or more motherboards. In some embodiments, some or all of these components are fabricated onto a single system on a chip (SoC) die. Additionally, in various embodiments, the computing device 600 may not include one or more of the components illustrated in FIG. 6, but the computing device 600 may include interface circuitry for coupling to the one or more components. For example, the computing device 600 may not include a display device 606, but may include display device interface circuitry (e.g., a connector and driver circuitry) to which a display device 606 may be coupled. In another set of examples, the computing device 600 may not include a video input device 618 or a video output device 608, but may include video input or output device interface circuitry (e.g., connectors and supporting circuitry) to which a video input device 618 or video output device 608 may be coupled.

The computing device 600 may include a processing device 602 (e.g., one or more processing devices). The processing device 602 processes electronic data from registers and/or memory to transform that electronic data into other electronic data that may be stored in registers and/or memory. The computing device 600 may include a memory 604, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 604 may include memory that shares a die with the processing device 602. In some embodiments, the memory 604 includes one or more non-transitory computer-readable media storing instructions executable for muting and/or unmuting a headset microphone and/or controlling another headset function, e.g., the method 500 described above in conjunction with FIG. 5 or some operations performed by the deep learning system 100 in FIG. 1. The instructions stored in the one or more non-transitory computer-readable media may be executed by the processing device 602.

In some embodiments, the computing device 600 may include a communication chip 612 (e.g., one or more communication chips). For example, the communication chip 612 may be configured for managing wireless communications for the transfer of data to and from the computing device 600. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 612 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005

Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 612 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 612 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 612 may operate in accordance with other wireless protocols in other embodiments. The computing device 600 may include an antenna 622 to facilitate wireless communications and/or to receive other wireless communications (such as AM or FM radio transmissions).

In some embodiments, the communication chip 612 may manage wired communications, such as electrical, optical, or any other suitable communication protocols (e.g., the Ethernet). As noted above, the communication chip 612 may include multiple communication chips. For instance, a first communication chip 612 may be dedicated to shorter-range wireless communications such as Wi-Fi or Bluetooth, and a second communication chip 612 may be dedicated to longer-range wireless communications such as global positioning system (GPS), EDGE, GPRS, CDMA, WiMAX, LTE, EV-DO, or others. In some embodiments, a first communication chip 612 may be dedicated to wireless communications, and a second communication chip 612 may be dedicated to wired communications.

The computing device 600 may include battery/power circuitry 614. The battery/power circuitry 614 may include one or more energy storage devices (e.g., batteries or capacitors) and/or circuitry for coupling components of the computing device 600 to an energy source separate from the computing device 600 (e.g., AC line power).

The computing device 600 may include a display device 606 (or corresponding interface circuitry, as discussed above). The display device 606 may include any visual indicators, such as a heads-up display, a computer monitor, a projector, a touchscreen display, a liquid crystal display (LCD), a light-emitting diode display, or a flat panel display, for example.

The computing device 600 may include a video output device 608 (or corresponding interface circuitry, as discussed above). The video output device 608 may include any device that generates an audible indicator, such as speakers, headsets, or earbuds, for example.

The computing device 600 may include a video input device 618 (or corresponding interface circuitry, as discussed above). The video input device 618 may include any device that generates a signal representative of a sound, such as microphones, microphone arrays, or digital instruments (e.g., instruments having a musical instrument digital interface (MIDI) output).

The computing device 600 may include a GPS device 616 (or corresponding interface circuitry, as discussed above). The GPS device 616 may be in communication with a satellite-based system and may receive a location of the computing device 600, as known in the art.

The computing device 600 may include another output device 610 (or corresponding interface circuitry, as discussed above). Examples of the other output device 610 may include a video codec, a video codec, a printer, a wired or wireless transmitter for providing information to other devices, or an additional storage device.

The computing device 600 may include another input device 620 (or corresponding interface circuitry, as discussed above). Examples of the other input device 620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 600 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 600 may be any other electronic device that processes data.

### Selected Examples

Example 1 provides a computer-implemented method, including receiving an audio data stream at a computing device, where the audio data stream is received from a headset microphone coupled to the computing device; processing the audio data stream in computing device firmware to identify a selected audio event; dividing the audio data stream into a first audio signal without the selected audio event and a residual audio signal including the selected audio event; transmitting the first audio signal to a capture sink at the computing device for transmission from the computing device; transmitting the residual audio signal to an event detector at the computing device; determining, at the event detector, that the selected audio event is a trigger event; and triggering a selected audio data action for one of audio data received from the headset microphone and audio data transmitted to headset speakers.

Example 2 provides the computer-implemented method of example 1, further including generating a sound notification to alert a user of the selected audio data action, and transmitting the sound notification to the headset speakers.

Example 3 provides the computer-implemented method of example 2, further including mixing the sound notification with incoming audio data to generate a mixed signal and transmitting the mixed signal to the headset speakers.

Example 4 provides the computer-implemented method of example 1, where dividing the audio data stream includes generating the first audio signal, and where generating the first audio signal includes subtracting the residual audio signal from the first audio data stream.

Example 5 provides the computer-implemented method of example 1, where the residual audio signal is the selected audio event.

Example 6 provides the computer-implemented method of example 1, where the selected audio data action is a mute action that mutes audio data received from the headset microphone by preventing transmission of the first audio signal to the capture sink.

Example 7 provides the computer-implemented method of example 1, where processing the audio data stream in computing device firmware includes inputting the audio data stream to a neural network configured to identify the selected audio event.

Example 8 provides one or more non-transitory computer-readable media storing instructions executable to perform operations, the operations including receiving an audio data stream at a computing device, where the audio data stream is received from a headset microphone coupled to the computing device; processing the audio data stream in computing device firmware to identify a selected audio event; splitting the audio data stream into a first audio signal without the selected audio event and a residual audio signal including the selected audio event; transmitting the first audio signal to a capture sink at the computing device for transmission from the computing device; transmitting the residual audio signal to an event detector at the computing device; determining, at the event detector, that the selected audio event is a trigger event; and triggering a selected audio data action for one of audio data received from the headset microphone and audio data transmitted to headset speakers.

Example 9 provides the one or more non-transitory computer-readable media of example 8, the operations further including generating a sound notification to alert a user of the selected audio data action, and transmitting the sound notification to the headset speakers.

Example 10 provides the one or more non-transitory computer-readable media of example 9, the operations further including mixing the sound notification with incoming audio data to generate a mixed signal and transmitting the mixed signal to the headset speakers.

Example 11 provides the one or more non-transitory computer-readable media of example 8, where splitting the audio data stream includes generating the first audio signal, and where generating the first audio signal includes subtracting the residual audio signal from the first audio data stream

Example 12 provides the one or more non-transitory computer-readable media of example 9, where the residual audio signal is the selected audio event.

Example 13 provides the one or more non-transitory computer-readable media of example 9, where the selected audio data action is a mute action that mutes audio data received from the headset microphone by preventing transmission of the first audio signal to the capture sink.

Example 14 provides the one or more non-transitory computer-readable media of example 9, where processing the audio data stream in computing device firmware includes inputting the audio data stream to a neural network configured to identify the selected audio event.

Example 15 provides an apparatus, including a computer processor for executing computer program instructions; and a non-transitory computer-readable memory storing computer program instructions executable by the computer processor to perform operations including receiving an audio data stream at a computing device, where the audio data stream is received from a headset microphone coupled to the computing device; processing the audio data stream in computing device firmware to identify a selected audio event; splitting the audio data stream into a first audio signal without the selected audio event and a residual audio signal including the selected audio event; transmitting the first audio signal to a capture sink at the computing device for transmission from the computing device; transmitting the residual audio signal to an event detector at the computing device; determining, at the event detector, that the selected audio event is a trigger event; and triggering a selected audio data action for one of audio data received from the headset microphone and audio data transmitted to headset speakers.

Example 16 provides the apparatus of example 15, the operations further including generating a sound notification to alert a user of the selected audio data action, and transmitting the sound notification to the headset speakers.

Example 17 provides the apparatus of example 16, the operations further including mixing the sound notification with incoming audio data to generate a mixed signal and transmitting the mixed signal to the headset speakers.

Example 18 provides the apparatus of example 15, where splitting the audio data stream includes generating the first audio signal, and where generating the first audio signal includes subtracting the residual audio signal from the first audio data stream

Example 19 provides the apparatus of example 15, where the residual audio signal is the selected audio event.

Example 20 provides the apparatus of example 15, where the selected audio data action is a mute action that mutes audio data received from the headset microphone by preventing transmission of the first audio signal to the capture sink.

The following paragraphs provide various examples of the embodiments disclosed herein.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving an audio data stream at a computing device, wherein the audio data stream is received from a headset microphone coupled to the computing device, wherein the headset microphone includes one of a headphones microphone, headbuds microphone, earphones microphone, and earbuds microphone;
processing the audio data stream in computing device firmware to identify a selected audio event;
dividing the audio data stream into a first audio signal without the selected audio event and a residual audio signal including the selected audio event;
transmitting the first audio signal to a capture sink at the computing device for transmission from the computing device;
transmitting the residual audio signal to an event detector at the computing device;
determining, at the event detector, that the selected audio event is a trigger event; and
triggering a selected audio data action for one of audio data received from the headset microphone and audio data transmitted to headset speakers.

2. The computer-implemented method of claim 1, further comprising generating a sound notification to alert a user of the selected audio data action, and transmitting the sound notification to the headset speakers.

3. The computer-implemented method of claim 2, further comprising mixing the sound notification with incoming audio data to generate a mixed signal and transmitting the mixed signal to the headset speakers.

4. The computer-implemented method of claim 1, wherein dividing the audio data stream includes generating the first audio signal, and wherein generating the first audio signal includes subtracting the residual audio signal from the audio data stream.

5. The computer-implemented method of claim 1, wherein the residual audio signal is the selected audio event.

6. The computer-implemented method of claim 1, wherein the selected audio data action is a mute action that mutes audio data received from the headset microphone by preventing transmission of the first audio signal to the capture sink.

7. The computer-implemented method of claim 1, wherein processing the audio data stream in computing device firmware includes inputting the audio data stream to a neural network configured to identify the selected audio event.

8. One or more non-transitory computer-readable media storing instructions executable to perform operations, the operations comprising:
receiving an audio data stream at a computing device, wherein the audio data stream is received from a headset microphone coupled to the computing device, wherein the headset microphone includes one of a headphones microphone, headbuds microphone, earphones microphone, and earbuds microphone;
processing the audio data stream in computing device firmware to identify a selected audio event;
dividing the audio data stream into a first audio signal without the selected audio event and a residual audio signal including the selected audio event;
transmitting the first audio signal to a capture sink at the computing device for transmission from the computing device;
transmitting the residual audio signal to an event detector at the computing device;
determining, at the event detector, that the selected audio event is a trigger event; and
triggering a selected audio data action for one of audio data received from the headset microphone and audio data transmitted to headset speakers.

9. The one or more non-transitory computer-readable media of claim 8, the operations further comprising generating a sound notification to alert a user of the selected audio data action, and transmitting the sound notification to the headset speakers.

10. The one or more non-transitory computer-readable media of claim 9, the operations further comprising mixing the sound notification with incoming audio data to generate a mixed signal and transmitting the mixed signal to the headset speakers.

11. The one or more non-transitory computer-readable media of claim 8, wherein dividing the audio data stream includes generating the first audio signal, and wherein generating the first audio signal includes subtracting the residual audio signal from the audio data stream.

12. The one or more non-transitory computer-readable media of claim 9, wherein the residual audio signal is the selected audio event.

13. The one or more non-transitory computer-readable media of claim 9, wherein the selected audio data action is a mute action that mutes audio data received from the headset microphone by preventing transmission of the first audio signal to the capture sink.

14. The one or more non-transitory computer-readable media of claim 9, wherein processing the audio data stream in computing device firmware includes inputting the audio data stream to a neural network configured to identify the selected audio event.

15. An apparatus, comprising:
a computer processor for executing computer program instructions; and
a non-transitory computer-readable memory storing computer program instructions executable by the computer processor to perform operations comprising:
receiving an audio data stream at a computing device, wherein the audio data stream is received from a headset microphone coupled to the computing device, wherein the headset microphone includes one of a headphones microphone, headbuds microphone, earphones microphone, and earbuds microphone;
processing the audio data stream in computing device firmware to identify a selected audio event;
dividing the audio data stream into a first audio signal without the selected audio event and a residual audio signal including the selected audio event;
transmitting the first audio signal to a capture sink at the computing device for transmission from the computing device;
transmitting the residual audio signal to an event detector at the computing device;
determining, at the event detector, that the selected audio event is a trigger event; and
triggering a selected audio data action for one of audio data received from the headset microphone and audio data transmitted to headset speakers.

16. The apparatus of claim 15, the operations further comprising generating a sound notification to alert a user of the selected audio data action, and transmitting the sound notification to the headset speakers.

17. The apparatus of claim 16, the operations further comprising mixing the sound notification with incoming audio data to generate a mixed signal and transmitting the mixed signal to the headset speakers.

18. The apparatus of claim 15, wherein dividing the audio data stream includes generating the first audio signal, and wherein generating the first audio signal includes subtracting the residual audio signal from the audio data stream.

19. The apparatus of claim 15, wherein the residual audio signal is the selected audio event.

20. The apparatus of claim 15, wherein the selected audio data action is a mute action that mutes audio data received from the headset microphone by preventing transmission of the first audio signal to the capture sink.
